(19) United States
(12) Patent Application Publication
(10) Pub. No.: US 2016/0008817 A1
(43) Pub. Date: Jan. 14, 2016

(54) GYRATORY CRUSHER MAIN SHAFT MOUNTING ASSEMBLY

(71) Applicant: SANDVIK INTELLECTUAL PROPERTY AB, Sandviken (SE)

(72) Inventors: Axel BERGMAN, Malmo (SE); Bengt-Arne ERIKSSON, Svedala (SE); Mikael M. LARSSON, Eslov (SE); Patric MALMQVIST, Svedala (SE)

(21) Appl. No.: 14/773,184

(22) PCT Filed: Jan. 27, 2014
(86) PCT No.: PCT/EP2014/051524

§ 371 Date: Sep. 4, 2015

(30) Foreign Application Priority Data
Mar. 8, 2013 (EP) 13158322.1

(51) Int. Cl. B02C 2/04

(52) U.S. Cl. CPC B02C 2/04

(57) ABSTRACT

A gyratory crusher eccentric support assembly supports the gyroscopic precession of a main shaft extending through the crusher. The eccentric assembly includes an inner bushing retained in position by a surrounding sleeve with the sleeve supported at its axially uppermost region by an annular support ring. A locking flange prevents axial displacement of the bushing that is configured specifically to facilitate the removal and replacement of the bushing wear part.

### FIELD OF INVENTION

The present invention relates to a mounting assembly for a main shaft of a gyratory crusher and in particular, although not exclusively, to an eccentric mounting assembly having an internal wear part bushing configured to be quickly and conveniently removed and reinstalled within a crusher to facilitate servicing and repair.

### BACKGROUND ART

Gyratory crushers are used for crushing ore, mineral and rock material to smaller sizes. Typically, the crusher comprises a crushing head (typically referred to as a mantle) mounted upon an elongate main shaft. A first crushing shell is mounted on the crushing head and a second crushing shell is mounted on a frame such that the first and second crushing shells define together a crushing chamber through which the material to be crushed is passed. A driving device positioned at a lower region of the main shaft is configured to rotate an eccentric assembly located about the shaft to cause the crushing head to perform a gyratory pendulum movement and crush the material introduced in the crushing chamber. Example gyratory crushers are described in WO 2004/110626; WO 2008/140375, WO 2010/123431, US 2009/0008489, GB 1570015, U.S. Pat. No. 6,536,693, JP 2004-136252, U.S. Pat. No. 1,791,584 and WO 2012/005651.

Conventionally, the driving device interfaces with drive components and bearings that provide and stabilize the gyroscopic precession of the shaft and crushing head within the crusher. These working parts are typically accommodated within a working part zone that is partitioned and sealed from the crushing chamber and the discharge zone (through which crushed material passes) by a sealing assembly. The working part zone is typically defined, at least partially, by a hub rigidly mounted at a lower shell of the crusher mainframe. The hub comprises an internal volume that mounts the rotatable eccentric assembly around the lower region of the main shaft.

Typically, a sleeve-like bushing is positioned in direct contact with the outer surface of the main shaft and through which the rotational drive is transmitted from the drive components to the main shaft and ultimately the mantle. Due to its function, the bushing is a wear part and requires replacement at regular intervals. Conventionally, an annular gasket is positioned at an upper region of the eccentric assembly and serves to prevent upward axial movement of the bushing during use. However, such a configuration is disadvantageous for maintenance of the crusher as the annular gasket and other selected components of the eccentric assembly must be dismantled to gain access to the bushing for removal and replacement. Accordingly, the maintenance process is time consuming and labour intensive which in turn result in undesirable crusher downtime. What is required is a mounting assembly for a lower region of the main shaft that addresses these problems.

### SUMMARY OF THE INVENTION

It is an object of the present invention to provide a mounting assembly for a main shaft of a gyratory crusher that is optimised to reduce the time and labour expenditure required to dismantle and reassemble the assembly during maintenance and repair operations. It is a further objective to provide an assembly that is operatively reliable and robust to extend, as far as possible, the operational lifetime of the various wear parts of the assembly between servicing.

The objectives are achieved by providing a mounting assembly for installation within the frame hub that comprises an inner tube-like bushing that may be conveniently removed and reintroduced axially into a surrounding sleeve and upper support ring. In particular, the tubular bushing is retained in its axial position about the main shaft by at least one locking flange that is releasably attached to the upper support ring via releasable fastenings. The locking flange projects downwardly onto an upper region of the bushing at a discreet region of the eccentric assembly. The present locking flange is relatively short in length (in the circumferential direction around the main shaft) and accordingly comprises a non-annular configuration. This relatively small bracket-like flange may be secured to the support ring via only one or two attachment bolts making its removal a quick and convenient procedure. This is to be contrasted with the conventional annular sealing gasket typically secured to an upper support ring over its entire circumference.

Additionally, the support ring of the present assembly comprises an internal bore having a diameter that is slightly greater than the external diameter of the cylindrical bushing such that the bushing may be removed and reinserted axially once the locking flange has been removed. That is, the locking flange only prevents upward axial movement of the bushing.

Advantageously, an upper face of the bushing comprises a mount for attachment of lifting eyelets that are engageable by suitable lifting apparatus (such as chains and the like).

According to a first aspect of the present invention there is provided a gyratory crusher comprising: a mainframe defining an internal crushing chamber; a main shaft extending within the chamber and providing a mount for a mantle capable of gyroscopic precession within the crusher; a hub having an internal volume in which a lower region of the main shaft is housed; an eccentric assembly at least partially mounted within the hub, the assembly comprising: a support ring positioned at an upper region of the hub and extending circumferentially around the main shaft; a sleeve projecting downwardly from the support ring and positioned radially between the main shaft and the hub; a removable bushing positioned radially between the sleeve and the main shaft; the crusher characterised by: at least one locking flange releasably attached to the support ring and configured to contact an upper face of the bushing to prevent upward axial movement of the bushing relative to the hub, the flange being non-annular to extend over only a part of an inner circumferential region of the support ring.

Preferably, the support ring and the sleeve are radially eccentric relative to an axis of the main shaft. More preferably, the bushing is also radially eccentric relative to the axis of the main shaft. Reference to ‘eccentric’ within this specification includes the relative wall thicknesses of the various components being non-uniform circumferentially and accordingly the non-central position of the bore of each competent relative to their respective perimeters.

Preferably, the inner circumferential region that defines the inner bore of the support ring comprises a diameter being at least the same or greater than an external diameter of the bushing. Optionally, an upper face of the bushing is positioned axially below an upward facing surface of the ring and wherein the flange comprises a bent region that projects axially downward from the support ring to contact the upper face of the bushing.

Optionally, a length of the locking flange is approximately equal to a width of the locking flange extending substantially in the circumferential direction. Optionally, the flange comprises a substantially planar first region and a substantially planar second region, the first and second regions being separated by a widthwise bend region such that a first region extends substantially perpendicular or transverse to the second region.

Preferably, the support ring comprises at least one female mount part to engage with at least one male mount member to releasably attach the locking flange to the support ring. Optionally, the female mount part comprises at least a pair of holes formed into an upward facing surface of the support ring and the male member comprises at least a pair of bolts. Optionally, the bushing comprises at least one female mount part at the upper face to engage with at least one male mount member to releasably attach the locking flange to the bushing. Optionally, the locking flange comprises an eyelet to allow attachment of lifting apparatus to remove the bushing axially upward from the hub.

Optionally, the bushing comprises a mount at an upper face to releasably attach an eyelet to allow attachment of lifting apparatus to remove the bushing axially upward from the hub.

Optionally, the crusher comprises two flanges releasably attached to the support ring. Optionally, the crusher may comprise a single flange or a plurality of flanged. Optionally, where the crusher comprises a plurality of flanges, the flanges are located in the same circumferential half region of the aperture of the support ring.

Optionally, the sleeve is formed non-integrally with support ring and attached to a downward facing surface of the support ring by a plurality of attachment bolts extending through the support ring and into a region of the sleeve.

Preferably, a wall thickness of the sleeve and the bushing in the radial direction is eccentric relative to an axis of the main shaft and wherein a position of the inner bore of the support ring is non-central and eccentric relative to a perimeter of the support ring.

Preferably, a radially outward facing surface the bushing comprises a radially outward projecting annular shoulder and a radially inward facing surface of the sleeve comprises an annular groove wherein the shoulder and the groove are configured to mate and prevent the bushing moving axially downward relative to the sleeve.

Preferably, a radially inward facing surface of the sleeve comprises at least one axially extending groove and a radially outward facing surface of the bushing comprises at least one axially extending channel; the crusher further comprising an elongate key accommodated in the groove and the channel to radially lock the sleeve and the bushing together as a unitary assembly.

### BRIEF DESCRIPTION OF DRAWINGS

A specific implementation of the present invention will now be described, by way of example only, and with reference to the accompanying drawings in which:

FIG. 1 is a cross section side view of a gyratory crusher having an upper frame part, a lower frame part and a rotatable main shaft accommodated within a crushing chamber wherein a lower region of the main shaft is supported by a mounting assembly according to a specific implementation of the present invention;

FIG. 2 is a perspective view of the mounting assembly of FIG. 1;

FIG. 3A is a perspective cross sectional view of the mounting assembly of FIG. 2;

FIG. 3B is a magnified perspective cross sectional view of the mounting assembly of FIG. 3A detailing the locking flange;

FIG. 4 is an underside view of the mounting assembly of FIGS. 3A and 3B;

FIG. 5 is a further perspective view of the mounting assembly of FIG. 2 configured for removal of the inner bushing axially upward from the assembly according to a specific implementation of the present invention;

FIG. 6 is an exploded view of the assembly of FIG. 5 with the inner bushing removed from the assembly.

### DETAILED DESCRIPTION OF PREFERRED EMBODIMENT OF THE INVENTION

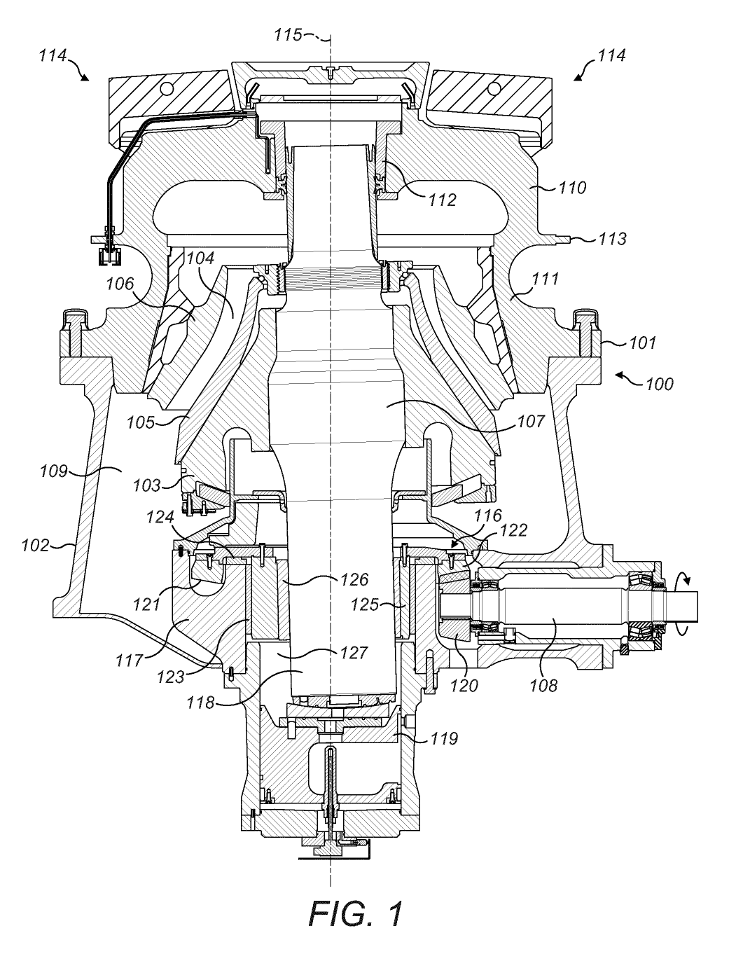

Referring to FIG. 1, a crusher comprises a frame 100 having an upper frame 101 and a lower frame 102. A crushing head (mantle) 103 is mounted upon an elongate shaft 107. A first (inner) crushing shell 105 is fixably mounted on crushing head 103 and a second (outer) crushing shell 106 is fixably mounted at upper frame 101. A crushing zone 104 is formed between the opposed crushing shells 105, 106. A discharge zone 109 is positioned immediately below crushing zone 104 and is defined, in part, by lower frame 102.

Upper frame 101 is further divided into a topshell 111, mounted upon lower frame 102 (alternatively termed a bottom shell), and a spider assembly 114 that extends from topshell 111 and represents an upper portion of the crusher. The spider 114 comprises two diametrically opposed arms 110 that extend radially outward from a central boss (not shown) positioned on a longitudinal axis 115 extending through frame 100 and the gyratory crusher generally. Arms 110 are attached to an upper region of topshell 111 via an intermediate annular flange 113 that is centred around longitudinal axis 115. Typically, arms 110 and topshell 111 form a unitary structure and are formed integrally.

A lower region 118 of shaft 107 is mounted within a mounting assembly 116 accommodated within a central hub 117 that is positioned centrally within bottom shell 102 about central longitudinal axis 115. A bearing assembly 119 is accommodated within a lower region of hub 117 and provides support for the gyroscopic precession of shaft 107 about axis 115.

Hub 117 comprises a generally cylindrical body that accommodates the majority of mounting assembly 116 that extends circumferentially around lower region 118 of main shaft 107 within an internal volume 127 of hub 117. In a radially outward direction from axis 115, mounting assembly 116 comprises an inner cylindrical bushing 126 surrounded by a sleeve 125 which is in turn journalled in position by an outermost sleeve-like bearing 123 positioned between an inner facing surface 307 of hub 117. A support ring 122 provides a mount for sleeve 125 and accordingly bushing 126. Ring 122 is positioned at an axially upper region of hub 117 axially between a lower region of mantle 103 and an upper region of hub 117. Support ring 122 is seated upon an annular ring-like bearing 124 that sits on top of an upper face end 308 of hub 117 such that an outer perimeter region 201 of ring 122 is approximately coplanar with an upper annular perimeter region 315 of hub 117.

Drive shaft 108 terminates at its radially innermost end in a pinion 120. Pinion 120 is journalled into contact with a downward facing annular gear 121 formed at an underside of support ring 122. In use, rotational motion of shaft 108 is translated via gears 120, 121 to rotate the mounting assembly 116 and in turn rotate main shaft 107.

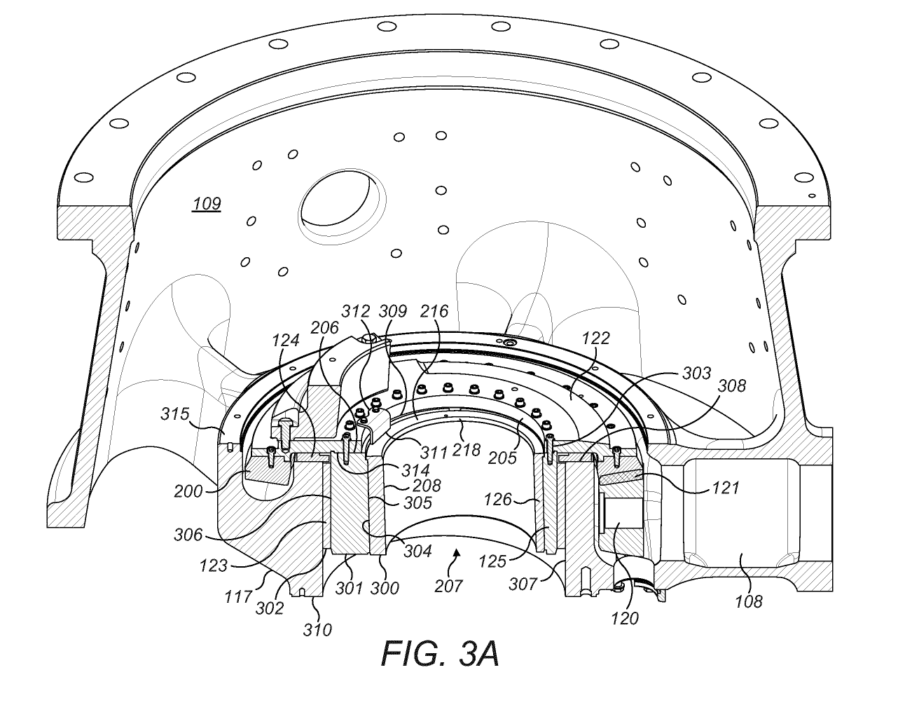

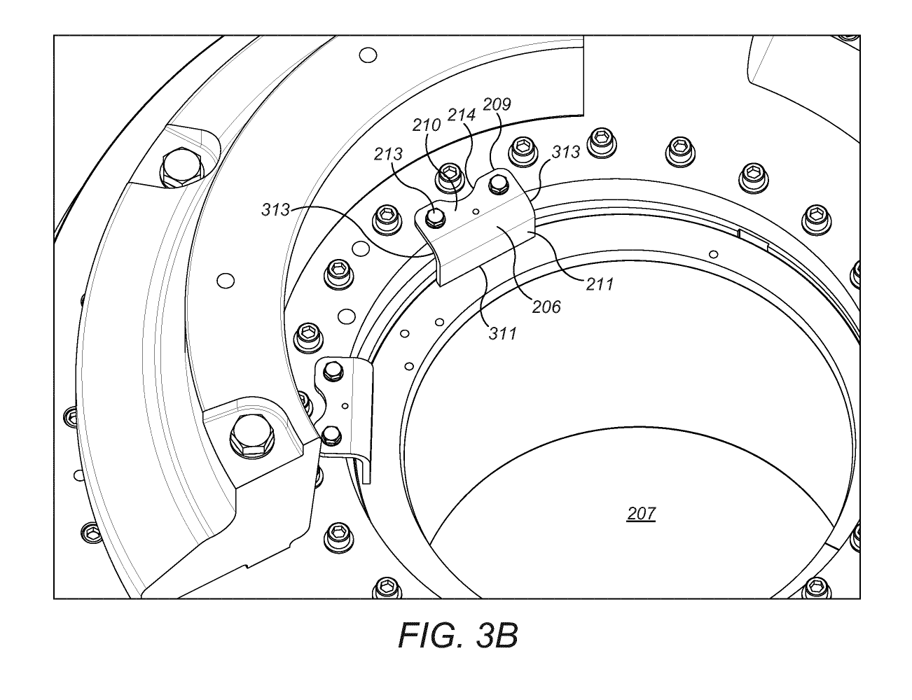

Assembly 116 is radially eccentric which imparts the gyroscopic precession of shaft 107 about axis 115. In particular and referring to FIGS. 1 to 4, support ring 122 comprises a circular aperture 205 that is positioned eccentrically relative to outer perimeter 201 of ring 122. Tubular sleeve 125 extends axially downward from a downward facing surface 314 of ring 122 such that an inner surface 305 of sleeve 125 is aligned approximately concentrically with aperture 205. However, as illustrated in FIG. 3, sleeve 125 is also eccentrically formed and comprises an eccentric wall thickness in a radial direction between inward facing surface 305 and an outward facing surface 306. An upper surface 202 of sleeve 125 is almost entirely positioned directly underneath downward facing surface 314 in both the radial and circumferential directions. However, approximately half of surface 206 in the circumferential direction projects radially inward from an axially lowermost edge 309 of aperture 205 to create a thin shoulder region. The wall thickness of sleeve 125 also tapers axially inward from uppermost annular surface 206 to a lowermost annular surface 301. Sleeve 125 is secured to ring 122 via a plurality of bolts 203 extending within suitable bores 303 extending through ring 122 between an upward facing surface 202 and downward facing surface 314. A counterweight 204 extends axially upward from upper surface 202 and acts to stabilise the rotational motion of the mounting assembly in use.

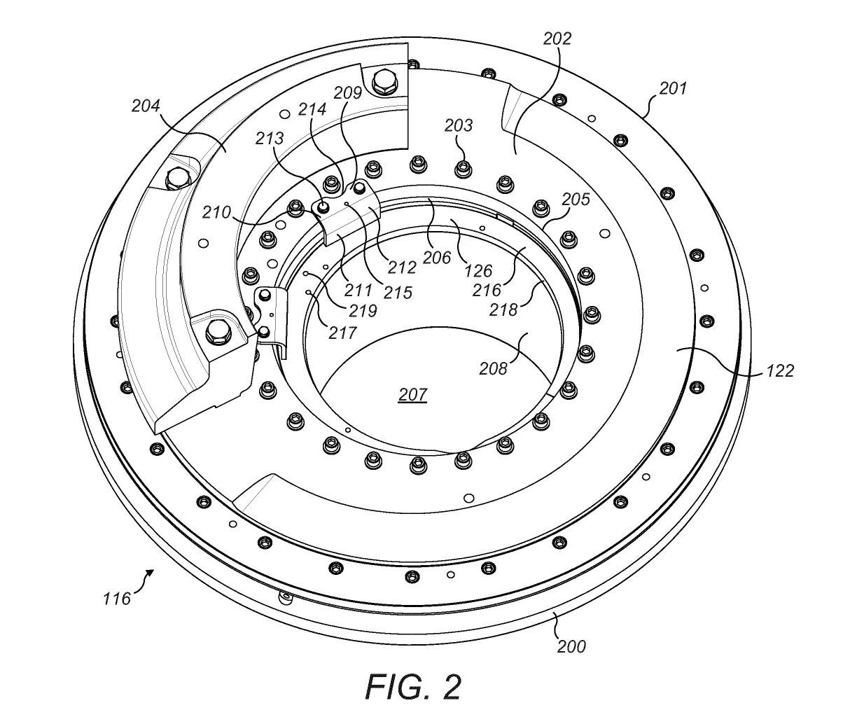

As illustrated in FIGS. 2 and 3, sleeve 125 is positioned axially lower than ring 122 such that an axially short cylindrical surface of aperture 205 is exposed. Bushing 126 is also formed eccentrically via its eccentric wall thickness extending radially between an outer facing surface 304 and an inner facing surface 307. Bushing 126 comprises a substantially uniform wall thickness between an uppermost annular end surface 216 and lowermost annular end surface 300. As surfaces 304, 305 are mated in close touching contact, bushing 126 is aligned at a transverse angle relative to axis 115 in a direction between upper and lower surfaces 216, 300. As illustrated in FIGS. 2 and 3, an innermost edge 218 at upper surface 216 is bevelled. A diameter at internal facing surface 208 is configured to be approximately equal to the external diameter of the lower region 118 of main shaft 107 so that the components fit in close touching contact.

Accordingly, the internal cylindrical volume 207 defined by the internal facing surface 208 of bushing 126 is oriented eccentrically relative to axis 115. As indicated, sleeve 125 is supported at its radially outward facing surface 306 by the sleeve-like bearing 123 that extends radially inward and in contact with inner facing surface 307 of hub 117.

Due to the axially transverse orientation of bushing 126 within sleeve 125, bushing upper surface 216 is not coplanar with sleeve upper surface 206. However, bushing surface 216 is positioned axially lower that the lowermost annular edge 309 that defines the axially lowermost part of aperture 205.

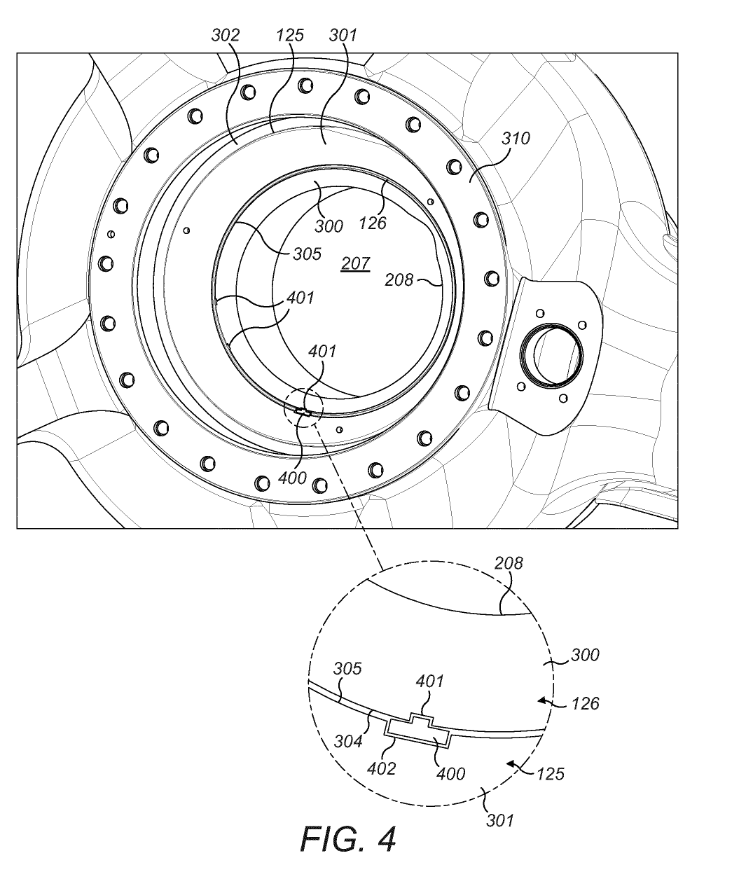

FIG. 4 illustrates the eccentric position of aperture 205 and the inner bore 207 extending axially through bushing 126 relative to a lowermost annular rim 310 of hub 117. FIG. 4 further illustrates the close contact between bushing 126 and sleeve 125 together with the relative wall thicknesses at the lowermost surfaces 300, 301 respectively and a lowermost surface 302 of cylindrical bearing 123.

Bushing 126 is secured to sleeve 125 by an elongate rod-like key 400. Key 400 is accommodated at least partially within an axially extending groove 402 formed at surface 305 of sleeve 125. A corresponding axially extending recess 401 is formed at surface 304 of bushing 126. Accordingly, bushing 126 is mated with sleeve 125 to prevent independent rotation about axis 115. As will be appreciated, bushing 126 comprises a plurality of longitudinal recesses 401 to adjust the degree of eccentric motion of shaft 107 via the different circumferential mating positions of bushing 126 relative to sleeve 125.

A diameter of aperture 205 is greater than a diameter across the external facing surface 304 of bushing 126 such that the innermost region of ring 122 does not radially overlap the upper bushing surface 216. This configuration allows the removal of bushing 126 without having to dismantle all or part of ring 122.

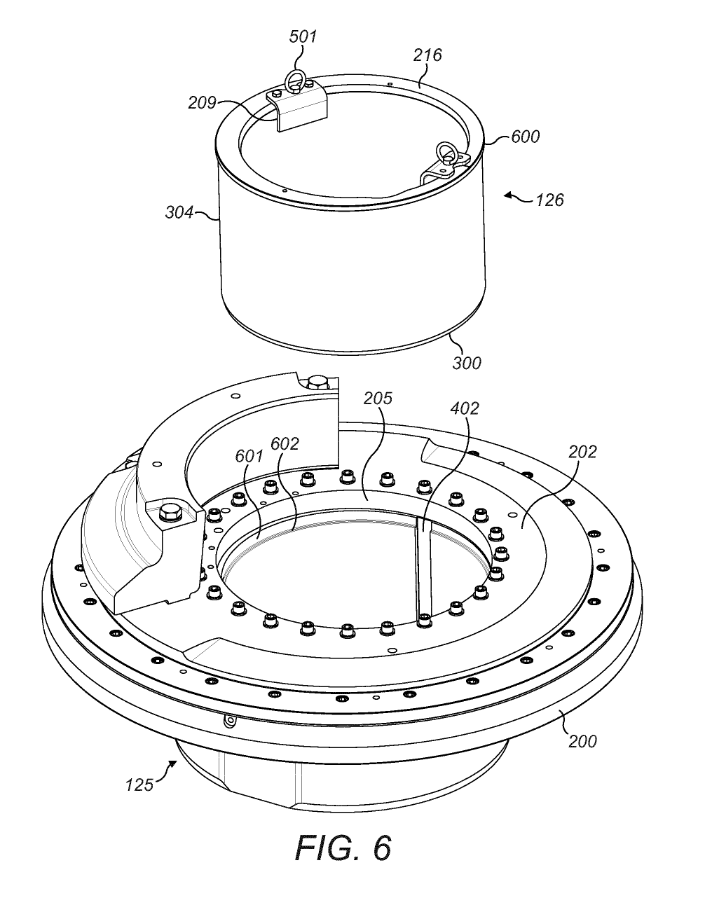

Referring to FIG. 6, the uppermost region of bushing 126 comprises an annular flange 600 that projects radially outward from surface 304 to define an annular shoulder. A corresponding annular recess 601 is formed in the uppermost region of sleeve 125 to define an annular lip 602 protruding from surface 305 and configured to engage shoulder 600.

Accordingly, as shoulder 600 is mated against lip 602, bushing 126 is prevented from downward axial movement to seat correctly within the eccentric assembly.

As will be appreciated, bushing 126 is a wear part and requires placing at regular intervals. The present mounting assembly is advantageous to provide convenient extraction and reintroduction of bushing 126. This is achieved, in part, via a removable locking flange 209 positioned at a region of ring 122 to bear down against bushing 126 and prevent its upward axial displacement. In particular, locking flange 209 is secured to upper face 202 of support ring 122 to overhang radially inward beyond aperture 205. Flange 209 is releasably secured to upper face 202 via a pair of attachment bolts 203 that extend through suitable bore holes provided within flange 209 to engage into threaded bore holes 500 positioned immediately radially outward from aperture 205.

Flange 209 comprises a first portion 210 extending substantially in a first plane parallel to surface 202 and a second portion 211 extends substantially perpendicular to first portion 210 and is aligned approximately with the longitudinal axis 115 extending through the crusher. The interface between the first and second portions 210, 211 comprises a bent region 212 without which flange 209 would be substantially planar. An end edge 312 of first portion 210 comprises a recess 401 for positioning about bolt 203 such that flange 209 may be accommodated at the region between aperture 205 and the circumferential array of bolts 203. A corresponding end edge 311 of second portion 211 is mated in contact with a region of bushing upper surface 216.

Flange 209 also comprises two opposed side edges 313 that, like edges 206 and 311, define the perimeter of flange 209. Edges 206 and 311 extend substantially perpendicular to the circumferential direction of aperture 205. As illustrated, flange 209 is non-annular to extend over only a discrete region of ring 122 and bushing 126. That is, a distance between edges 206 and 311 is in the range 2 to 10% of the circumferential length around aperture 205. According to further specific implementations, flange 209 is secured to ring 122 by a single attachment element 213 to further reduce the time and effort required to remove the axial lock on bushing 126. According to the specific implementation, the crusher comprises two locking flanges 209 extending between support ring 122 and bushing 126 to lock bushing 126 axially within the internal bore 127 of hub 117. According to further specific implementations, the eccentric assembly may comprise a single flange 209.

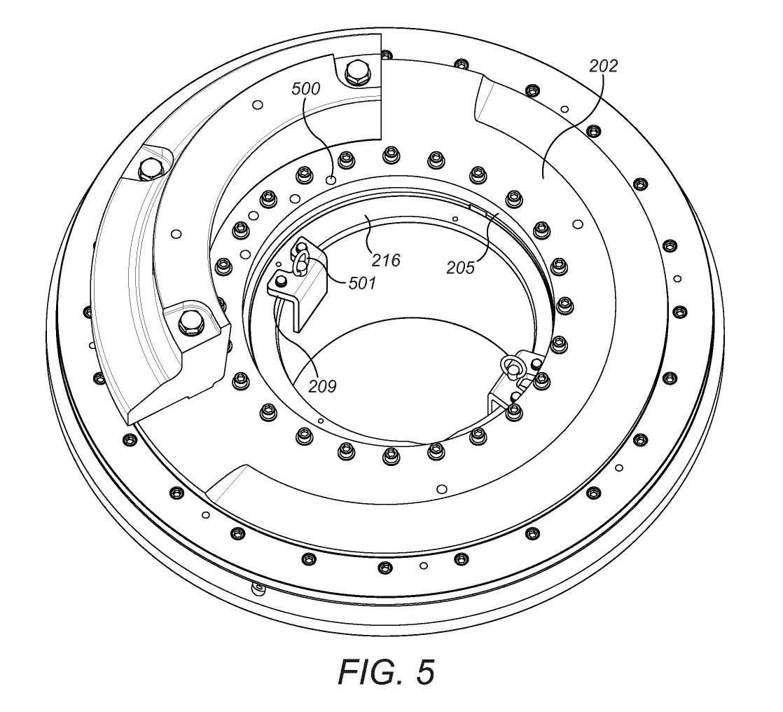

Each locking flange 209 comprises a bore 215 formed in first portion 210. Referring to FIGS. 5 and 6, bore 215 is configured to receive and engage with a shaft of an eyelet 501 configured for attachment to suitable lifting apparatus. When bushing 126 requires replacement, each flange 209 is conveniently released from attachment to support ring 122 by unfastening bolts 203. The same flange 209 is then secured to upper surface 216 of bushing 126 via engagement of bolts 203 into bore holes 500 extending axially into bushing 126 from surface 216. As indicated previously, given the relative diameters of aperture 205 and the external diameter of bushing 126, the inner bushing 126 may then be lifted vertically from assembly 116 using suitable lifting apparatus.

Accordingly to further specific implementations, eyelet 501 may be secured directly to bushing 126 via a corresponding bore 219 formed in upper surface 216. A replacement bushing 126 may then be conveniently reintroduced into assembly 116 by the reverse procedure involving reattachment of flanges 209 at support ring 122 as a final step to lock bushing axially within the eccentric assembly.

1. A gyratory crusher comprising:
a mainframe defining an internal crushing chamber;
a main shaft extending within the chamber and providing a mount for a mantle capable of gyroscopic precession within the crusher;
a hub having an internal volume in which a lower region of the main shaft is housed;
an eccentric assembly at least partially mounted within the hub, the assembly including a support ring positioned at an upper region of the hub and extending circumferentially around the main shaft; a sleeve projecting downwardly from the support ring and positioned radially between the main shaft and the hub; a removable bushing positioned radially between the sleeve and the main shaft; and
at least one locking flange releasably attached to the support ring and configured to contact an upper face of the bushing to prevent upward axial movement of the bushing relative to the hub, the flange being non-annular to extend over only a part of an inner circumferential region of the support ring.

2. The crusher as claimed in claim 1, wherein the inner circumferential region that defines the inner bore of the support ring has a diameter being at least the same or greater than an external diameter of the bushing.

3. The crusher as claimed in claim 1, wherein the upper face of the bushing is positioned axially below an upward facing surface of the ring and wherein the flange includes a bent region that projects axially downward from the support ring to contact the upper face of the bushing.

4. The crusher as claimed in claim 1, wherein a length of the locking flange is approximately equal to a width of the locking flange extending substantially in the circumferential direction.

5. The crusher as claimed in claim 1, wherein the flange includes a substantially planar first region and a substantially planar second region, the first and second regions being separated by a widthwise bend region such that the first region extends substantially perpendicular or transverse to the second region.

6. The crusher as claimed in claim 1, wherein the support ring includes at least one female mount part to engage with at least one male mount member to releasably attach the locking flange to the support ring.

7. The crusher as claimed in claim 6, wherein the female mount part includes at least a pair of holes formed into an upward facing surface of the support ring and the male member includes at least a pair of bolts.

8. The crusher as claimed in claim 1, wherein the bushing includes at least one female mount part at the upper face to engage with at least one male mount member to releasably attach the locking flange to the bushing.

9. The crusher as claimed in claim 8, wherein the locking flange includes an eyelet to allow attachment of lifting apparatus to remove the bushing axially upward from the hub.

10. The crusher as claimed in claim 1, wherein the bushing includes a mount at an upper face to releasably attach an eyelet to allow attachment of lifting apparatus to remove the bushing axially upward from the hub.

11. The crusher as claimed in claim 1, further comprising two flanges releasably attached to the support ring.

12. The crusher as claimed in claim 1, wherein the sleeve is formed non-integrally with support ring and attached to a downward facing surface of the support ring by a plurality of attachment bolts extending through the support ring an into a region of the sleeve.

13. The crusher as claimed in claim 1, wherein a wall thickness of the sleeve and the bushing in the radial direction is eccentric relative to an axis of the main shaft and wherein a position of the inner bore of the support ring is non-central and eccentric relative to a perimeter of the support ring.

14. The crusher as claimed in claim 1, wherein a radially outward facing surface the bushing includes a radially outward projecting annular shoulder and a radially inward facing surface of the sleeve includes a annular groove, wherein the shoulder and the groove are configured to mate and prevent the bushing moving axially downward relative to the sleeve.

15. The crusher as claimed in claim 1, wherein a radially inward facing surface of the sleeve includes at least one axially extending groove and a radially outward facing surface the bushing includes at least one axially extending channel; the crusher further comprising an elongate key accommodated in the groove and the channel to radially lock the sleeve and the bushing together as a unitary assembly.
